(19) United States
(12) Patent Application Publication
(10) Pub. No.: US 2026/0254931 A1
(43) Pub. Date: Aug. 27, 2026

(54) METHOD OF CONTROLLING TERMINAL APPARATUS, NON-TRANSITORY COMPUTER-READABLE STORAGE MEDIUM STORING PROGRAM, AND PROJECTION SYSTEM

(71) Applicant: SEIKO EPSON CORPORATION, Tokyo (JP)

(72) Inventor: Hiroyuki ICHIEDA, Matsumoto-shi (JP)

(73) Assignee: SEIKO EPSON CORPORATION, Tokyo (JP)

(21) Appl. No.: 19/549,205

(22) Filed: Feb. 25, 2026

(30) Foreign Application Priority Data
Feb. 26, 2025 (JP) 2025-028681

(51) Int. Cl. H04N 9/31; G06T 7/521; G06T 7/73; G06V 40/10; H04N 23/11

(52) U.S. Cl. CPC H04N 9/3185; G06T 7/521; G06T 7/73; G06V 40/10; H04N 23/11

(57) ABSTRACT

A processor causes a touch panel to display an inquiry image, acquires a captured image of a screen captured by a camera, calculates a first correction value for correcting at least one of a shape and a position of an image based on a second side of the screen different from a first side in a captured image when a first response representing that a detection light irradiation device is located in an area at an inner side with respect to the first side is received, and calculates a second correction value for correcting at least one of the shape and the position of the image based on both the first side and the second side in the captured image when a second response representing that the detection light irradiation device is located at an outer side of the screen with respect to the first side is received.

The present application is based on, and claims priority from JP Application Serial Number 2025-028681, filed Feb. 26, 2025, the disclosure of which is hereby incorporated by reference herein in its entirety.

### BACKGROUND

### 1. Technical Field

The present disclosure relates to a method of controlling a terminal apparatus, a non-transitory computer-readable storage medium storing a program, and a projection system.

### 2. Related Art

In the past, there has been known a technique of correcting a shape of an image to be projected on a projection surface based on a captured image by a camera.

For example, an image display apparatus disclosed in JP-A-2014-27457 captures, with an imaging unit, an image of a pattern projected on a projection surface by a projection unit and an image of a projection target, and detects a relative positional relationship between an image of a projection panel corresponding to the image of the pattern and the image of the projection target based on the images thus captured. Subsequently, in the image display apparatus, a corrector performs correction based on a detection result by the image analyzer.

JP-A-2014-27457 is an example of the related art.

However, when an obstacle is located within the projection surface, the calculation accuracy of a correction value obtained by an image analysis of the captured images is degraded, and the accuracy of the correction of the images based on the correction value is also degraded.

### SUMMARY

The present disclosure is a method of controlling a terminal apparatus including a camera configured to image a projection target on which an image is projected from a projection apparatus, a display, and at least one processor, the method including: making the at least one processor cause the display to display an inquiry image that asks whether an object different from the projection target is located in an area at an inner side of the projection target with respect to a first side of the projection target or the object is located in an area at an outer side of the projection target with respect to the first side of the projection target; making the at least one processor acquire a captured image of the projection target imaged by the camera; making the at least one processor calculate a first correction value for correcting at least one of a shape and a position of the image based on a second side of the projection target different from the first side in the captured image when a first response representing that the object is located in the area at the inner side with respect to the first side is received; and making the at least one processor calculate a second correction value for correcting at least one of the shape and the position of the image based on both the first side and the second side in the captured image when a second response representing that the object is located at the outer side of the projection target with respect to the first side is received.

The present disclosure is a non-transitory computer-readable storage medium storing a program causing a computer configured to control a terminal apparatus including a camera configured to image a projection target on which an image is projected from a projection apparatus and a display to execute processing including: causing the display to display an inquiry image that asks whether an object different from the projection target is located in an area at an inner side of the projection target with respect to a first side of the projection target or the object is located in an area at an outer side of the projection target with respect to the first side of the projection target; acquiring a captured image of the projection target imaged by the camera; calculating a first correction value for correcting at least one of a shape and a position of the image based on a second side of the projection target different from the first side in the captured image when a first response representing that the object is located in the area at the inner side with respect to the first side is received; and calculating a second correction value for correcting at least one of the shape and the position of the image based on both the first side and the second side in the captured image when a second response representing that the object is located at the outer side of the projection target with respect to the first side is received.

The present disclosure is a projection system including: a projection apparatus including a receiving circuit configured to receive data, and configured to project an image on a projection target; and a terminal apparatus including a camera configured to image the projection target, a display, at least one processor, and a transmitting circuit configured to transmit the data, wherein the at least one processor executes causing the display to display an inquiry image that asks whether an object different from the projection target is located in an area at an inner side of the projection target with respect to a first side of the projection target or the object is located in an area at an outer side of the projection target with respect to the first side of the projection target, acquiring a captured image of the projection target imaged by the camera, calculating a first correction value for correcting at least one of a shape and a position of the image based on a second side of the projection target different from the first side in the captured image when a first response representing that the object is located in the area at the inner side with respect to the first side is received, calculating a second correction value for correcting at least one of the shape and the position of the image based on both the first side and the second side in the captured image when a second response representing that the object is located at the outer side of the projection target with respect to the first side is received, and transmitting, with the transmitting circuit, the first correction value or the second correction value to the projection apparatus, and the projection apparatus executes projecting, on the projection target, a corrected image as the image corrected based on the first correction value or the second correction value received by the receiving circuit.

### BRIEF DESCRIPTION OF THE DRAWINGS

FIG. 1 is a diagram illustrating a system configuration of a projection system.

FIG. 2 is a perspective view showing an installation state of a projection apparatus.

FIG. 3 is a block diagram showing a configuration of the projection apparatus.

FIG. 4 is a diagram showing a configuration of a projector.

FIG. 5 is a block diagram showing a configuration of a terminal apparatus.

FIG. 6 is a diagram showing a shape of a projection area after correction when a detection light irradiation device is erroneously recognized as a part of a screen frame.

FIG. 7 is a flowchart showing an operation of a controller of the terminal apparatus.

FIG. 8 is a diagram showing an example of a guide image.

FIG. 9 is a diagram showing an example of an inquiry image.

FIG. 10 is a diagram showing an example of a first projection pattern image.

FIG. 11 is a diagram showing an example of a second projection pattern image.

FIG. 12 is a flowchart showing an overall operation of the terminal apparatus.

FIG. 13 is a diagram illustrating missing side compensation processing.

FIG. 14 is a diagram illustrating the missing side compensation processing.

FIG. 15 is a diagram illustrating the missing side compensation processing.

FIG. 16 is a diagram illustrating the missing side compensation processing.

FIG. 17 is a diagram illustrating the missing side compensation processing.

FIG. 18 is a flowchart showing a processing operation of the missing side compensation processing when an upper side and a lower side are detected.

FIG. 19 is a diagram illustrating the missing side compensation processing.

FIG. 20 is a diagram illustrating the missing side compensation processing.

FIG. 21 is a diagram illustrating the missing side compensation processing.

FIG. 22 is a flowchart showing a processing operation of the missing side compensation processing when the upper side and a left side are detected.

FIG. 23 is a diagram illustrating the missing side compensation processing.

FIG. 24 is a diagram illustrating the missing side compensation processing.

FIG. 25 is a diagram illustrating the missing side compensation processing.

FIG. 26 is a diagram illustrating the missing side compensation processing.

FIG. 27 is a diagram illustrating the missing side compensation processing.

FIG. 28 is a flowchart showing an operation of calculating the correction value for correcting the shape of the projection area from a normal vector of a screen.

FIG. 29 is a diagram showing an output of a triaxial acceleration sensor, the normal vector of the vanishing point, and a horizontal screen, a vertical

FIG. 30 is a diagram showing four vertices of a liquid crystal panel in a normalized panel coordinate system.

FIG. 31 is a diagram showing coordinates of four vertices in a screen coordinate system after vanishing point. conversion.

FIG. 32 is a diagram showing an intersection of a rectangular figure centered on an intersection of diagonals and a quadrangle configured with the four vertices in the screen coordinate system after the conversion.

FIG. 33 is a diagram showing a rectangular figure after enlargement.

FIG. 34 is a diagram showing the rectangular figure after the enlargement.

### DESCRIPTION OF EMBODIMENTS

### 1. Configuration of Projection System

Some embodiments will hereinafter be described with reference to the accompanying drawings.

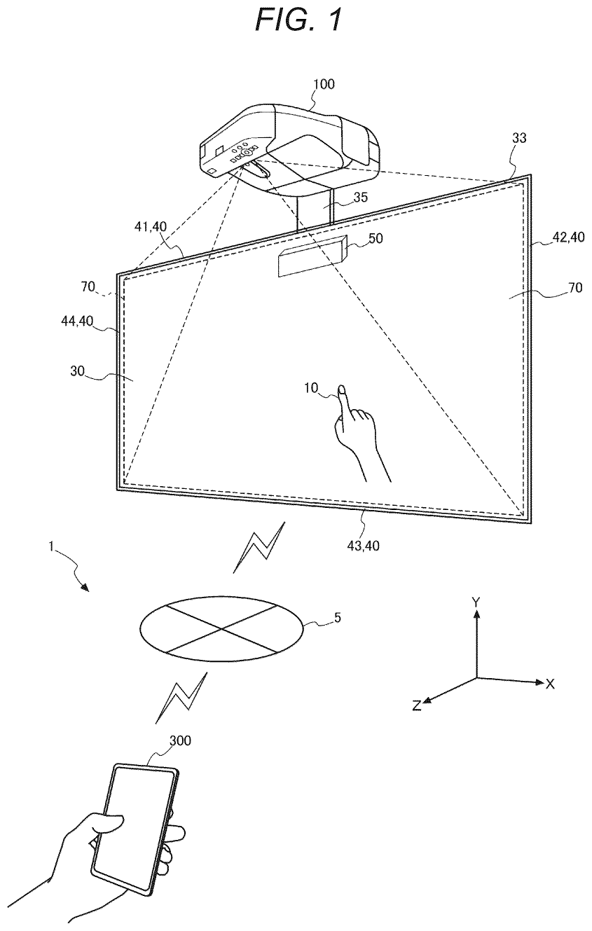

FIG. 1 is a diagram showing a system configuration of a projection system 1.

The projection system 1 includes a projection apparatus 100 that projects an image on a screen 30 as a projection surface and a terminal apparatus 300, and these apparatuses are connected via a network 5. The screen corresponds to an example of a projection target.

The projection apparatus 100 displays a projection image in a projection area 70 of the screen 30 by projecting image light onto the screen 30. The projection image is an image which is displayed by the projection apparatus 100 projecting the image light onto the screen 30. The projection area 70 is an area of the screen 30 on which the projection apparatus 100 can project the image light.

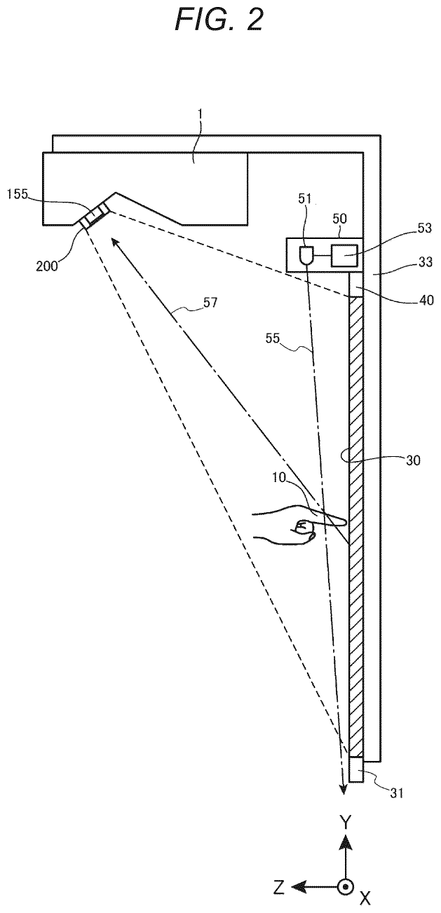

Then, a configuration of the projection apparatus 100 will be described with reference to FIGS. 1 and 2. FIG. 2 is a perspective view showing an installation state of the projection apparatus.

FIGS. 1 and 2 show an X axis, a Y axis, and a Z axis orthogonal to each other. The Y axis is parallel to a vertical direction, and each of the X axis and the Z axis is parallel to a horizontal direction. In FIGS. 1 and 2, the screen 30 is parallel to the Y axis. When standing toward the screen 30, the X axis represents a left-right direction, and the Z axis represents a front-rear direction. A positive direction of the X axis represents a rightward direction, a positive direction of the Y axis represents an upward direction, and a positive direction of the Z axis represents a forward direction.

A screen plate 33 is disposed at a position on which the projection apparatus 100 projects the image light. A front surface of the screen plate 33 is used as the screen 30. The screen 30 in the present embodiment has a rectangular shape having long sides parallel to the X axis and short sides parallel to the Y axis. The projection apparatus 100 is fixed by the support member 35 at a front side and an upper side with respect to the screen plate 33.

Although the screen 30 is disposed along the vertical direction in FIG. 1, the screen 30 may be disposed along the horizontal direction. Further, in the present embodiment, there is exemplified when the projection apparatus 100 performs projection on the screen 30 as a flat surface, but the projection target is not limited to the screen 30, and may be a flat surface such as a wall surface of a building, and may also be a curved surface, or an uneven surface.

The periphery of the screen 30 is surrounded by a screen frame 40 formed of four frame sides of an upper frame side 41, a right frame side 42, a lower frame side 43, and a left frame side 44 in a drawing view. When a blackboard or a whiteboard is used as the screen 30, the lower frame side 43 functions as, for example, a tray for chokes or markers. Note that there may be adopted a configuration in which the screen 30 is provided only with the lower frame side 43, or the screen frame 40 is not required to be formed on the periphery of the screen 30.

Further, in the projection system 1, a position pointing operation can be performed with a pointer 10 on the screen 30, and the projection apparatus 100 detects the pointed position pointed by the pointer 10. The pointer 10 is a pen, a finger of a user, or the like. In the present embodiment, there is described when the pointer 10 is a finger of the user.

The projection apparatus 100 includes a projector 200, an imaging unit 150 including a camera 155, a detection light irradiation device 50, and an operation panel (not shown) including a plurality of operation buttons. The projector 200 projects the projection image on the screen 30. The camera 155 captures the projection image to output a captured image. A field angle of the camera 155, that is, an imaging range is a range including at least the projection image on the screen 30. A projection lens of the projector 200 and an imaging lens of the camera 155 are disposed at a lower surface of the projection apparatus 100.

The detection light irradiation device 50 corresponds to an example of a detection apparatus as an object. As shown in FIG. 2, the detection light irradiation device 50 emits detection light 55 in order to detect the pointing position of the pointer 10. The object is not required to be the detection light irradiation device 50, and may be, for example, furniture or an obstacle. The detection light irradiation device 50 is disposed at, for example, a position above the upper frame side 41, a position overlapping the upper frame side 41, or a position below the upper frame side 41, that is, an upper position in the region of the screen 30.

The detection light irradiation device 50 emits the detection light 55 for detecting a tip portion of the pointer 10 in a direction of covering the screen 30. Specifically, the detection light irradiation device 50 emits the detection light 55 in a planar shape along the screen 30. As the detection light 55 emitted by the detection light irradiation device 50, near-infrared light, for example, is used.

The detection light irradiation device 50 includes an emitter 51 and an adjustment mechanism 53 that adjusts an emission direction in which the emitter 51 emits infrared light. The detection light irradiation device 50 may have a configuration including a plurality of emitters 51.

A region where the detection light irradiation device 50 emits the detection light 55 is an area including the projection area 70, preferably an area including the screen 30.

In a normal mode in which an operation by the pointer 10 is detected, the projection apparatus 100 in which the detection light 55 is adjusted detects, as a bright spot from the captured image of the camera 155, reflected detection light 57, which is reflected light obtained by the pointer 10 reflecting the detection light 55 emitted by the detection light irradiation device 50. In this case, it is possible to detect an operation of the pointer 10 in an area from which the detection light 55 is emitted and which is within the field angle of the camera 155. In other words, the area within the field angle of the camera 155 out of the area in which the detection light irradiation device 50 emits the detection light 55 is a detection area in which the operation of the pointer 10 can be detected.

The camera 155 has at least a first imaging function of receiving and imaging light in a wavelength region including the wavelength of the detection light 55 emitted by the detection light irradiation device 50. It is preferable for the camera 155 to further have a second imaging function of receiving and imaging light including visible light, and to be configured to be able to switch between these two imaging functions.

For example, it is preferable for the camera 155 to include a near-infrared filter switching mechanism (not illustrated) capable of disposing a near-infrared filter that blocks the visible light and transmits only near-infrared light in front of the lens, or retracting the near-infrared filter from the front of the lens.

The projection apparatus 100 detects a pointing operation of the pointer 10, identifies a pointing position, and performs an operation corresponding to the pointing position. For example, the projection apparatus 100 operates in a whiteboard mode in which a character, a figure, a line drawing, and so on are drawn and projected as the projection image in accordance with the operation of the pointer 10.

Further, the projection apparatus 100 can also operate in another mode than the whiteboard mode, and can execute an operation mode of projecting the projection image based on image data input from an image source (not shown) such as a personal computer.

### 2. Configuration of Projection Apparatus

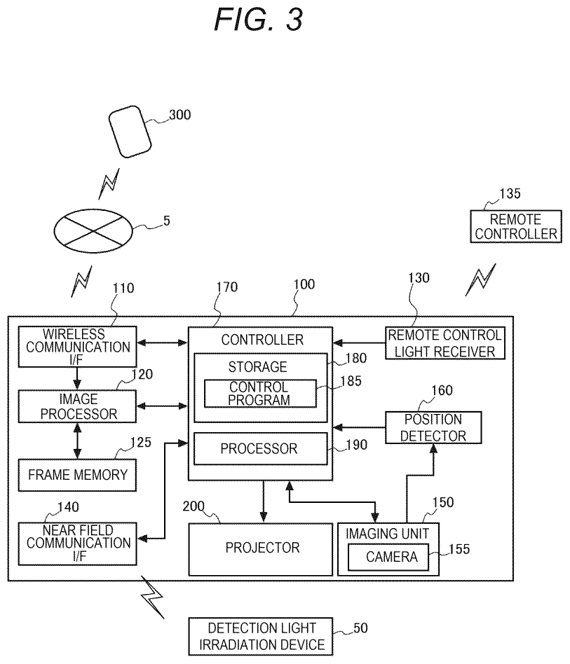

FIG. 3 is a block diagram showing a configuration of the projection apparatus 100.

The projection apparatus 100 includes a wireless communication interface 110, an image processor 120, a frame memory 125, a remote control light receiver 130, a near field communication interface 140, an imaging unit 150, a projector 200, and a controller 170. Interface will hereinafter be abbreviated as I/F.

The wireless communication I/F 110 includes, for example, an interface circuit compliant with a communication standard of wireless communication such as Wi-Fi, and is connected to the network 5. The wireless communication I/F 110 performs mutual data communication with an external apparatus including the terminal apparatus 300 via the network 5. Wi-Fi is a registered trademark. The wireless communication I/F 110 corresponds to an example of a receiving circuit.

The image data received by the wireless communication I/F 110 from the external apparatus is input to the image processor 120. The frame memory 125 is coupled to the image processor 120. The frame memory 125 includes a plurality of banks. Each of the banks has a storage capacity sufficient for writing image data corresponding to one frame. The frame memory 125 is formed of, for example, a synchronous dynamic random-access memory (SDRAM). The image processor 120 loads the image data input from the communication I/F 110 into the frame memory 125.

The image processor 120 performs image processing on the image data loaded in the frame memory 125. Examples of the image processing performed by the image processor 120 include resolution conversion processing, resizing processing, distortion aberration correction, shape correction processing, digital zoom processing, and adjustment of the tint and luminance of an image. The image processor 120 executes processing designated by the controller 170, and performs processing using a parameter input from the controller 170, as needed. Further, it is obviously possible for the image processor 120 to execute a plurality of types of image processing in combination out of the types of image processing described above. The image processor 120 reads, from the frame memory 125, the image data loaded in a bank selected by the controller 170 and outputs the image data thus read to the projector 200.

The image processor 120 and the frame memory 125 include, for example, an integrated circuit. Examples of the integrated circuit include a large scale integration (LSI), an application-specific integrated circuit (ASIC), a programmable logic device (PLD), a field-programmable gate array (FPGA), a system-on-a-chip (SoC), and the like. Further, an analog circuit may be provided as a part of a configuration of the integrated circuit, or a configuration in which the controller 170 and the integrated circuit are combined with each other may be adopted.

The remote control light receiver 130 receives an infrared signal transmitted from a remote controller 135. The remote controller 135 includes a plurality of buttons such as a power button and a source switching button. The remote controller 135 transmits, to the projection apparatus 100, an infrared signal corresponding to a button operated by the user. The remote control light receiver 130 outputs, to the controller 170, an operation signal according to the infrared signal thus received. The operation signal is a signal corresponding to one of the buttons of the remote controller 135 operated by the user.

The near field communication I/F 140 includes an interface circuit compliant with a communication standard of wireless communication such as Bluetooth, and is wirelessly connected to the detection light irradiation device 50. The near field communication I/F 140 transmits, to the detection light irradiation device 50, a control signal input from the controller 170. Bluetooth is a registered trademark.

The imaging unit 150 includes the camera 155. The camera 155 receives and images the light in the wavelength region including the wavelength of the detection light 55 described with reference to FIG. 2. The camera 155 receives and images the reflected detection light 57 which is the reflected light obtained by the pointer 10 reflecting the detection light 55 emitted by the detection Light irradiation device 50. Therefore, the reflected detection light 57 can be detected from the captured image of the camera 155.

It is preferable for the camera 155 to have a function of performing imaging using the light including visible light in addition to the function of performing imaging using the light including near-infrared light. In this case, the projection image projected on the screen 30 can be captured by the camera 155, and the controller 170 can execute a keystone distortion correction, a color correction, and so on using that image.

The position detector 160 detects the reflected detection light 57 from the captured image of the camera 155. The position detector 160 specifies the position in the captured image with respect to the detected light image to detect the position of the pointer 10.

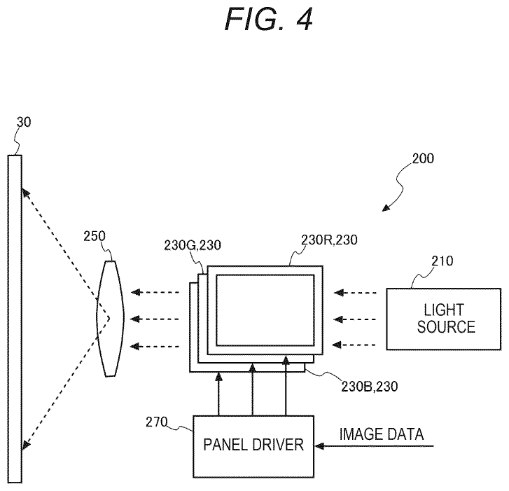

FIG. 4 is a diagram showing a configuration of the projector 200.

Here, the configuration of the projector 200 will be described with reference to FIG. 4.

The projector 200 modulates light emitted from a light source 210 with the liquid crystal panel 230 to generate the image light, and projects, with an optical unit 250, the image light thus generated in an enlarged manner. The projector 200 includes the light source 210, three liquid crystal panels 230R, 230G, and 230B as light modulation devices, the optical unit 250, and a panel driver 270. Hereinafter, the liquid crystal panels 230R, 230G, and 230B provided to the projector 200 are collectively referred to as liquid crystal panels 230.

The Light source 210 includes a discharge-type light source lamp such as an ultra-high-pressure mercury lamp or a metal halide lamp, or a solid-state light source such as a light emitting diode or a semiconductor laser. The Light emitted from the light source 210 is incident on the liquid crystal panel 230. Each of the liquid crystal panels 230R, 230G, and 230B is configured with a transmissive liquid crystal panel obtained by encapsulating a liquid crystal between a pair of transparent substrates. The liquid crystal panel 230R modulates red light, the liquid crystal panel 230G modulates green light, and the liquid crystal panel 230B modulates blue light. Each of the liquid crystal panels is provided with a pixel area including a plurality of pixels arranged in a matrix, and is configured to be able to apply a drive voltage to the liquid crystal pixel by pixel.

The image data processed by the image processor 120 is input to the panel driver 270. The panel driver 270 applies the drive voltage according to the image data input thereto to each of the pixels in the pixel area to set the pixel to a light transmittance according to the image data. The light emitted from the light source 210 is modulated pixel by pixel by being transmitted through the pixel areas in the liquid crystal panels 230R, 230G, and 230B, and thus, the image light corresponding to the image data is formed for each colored light. The image light of the respective colors thus formed is combined pixel by pixel by a color combining optical system (not illustrated) to form the image light representing a color image. The optical unit 250 includes a projection lens and so on to project the image light modulated respectively by the liquid crystal panels 230R, 230G, and 230B onto the screen 30 in an enlarged manner.

Going back to FIG. 1, the configuration of the projection apparatus 100 will continuously be described.

The controller 170 is a computer device including a storage 180 and a processor 190.

The storage 180 includes a random-access memory (RAM) and a read-only memory (ROM). The RAM is used as, for example, an arithmetic area of the processor 190. The ROM stores a control program 185 for controlling an operation of the processor 190 and various types of configuration data.

The processor 190 is an arithmetic processing device including a central processing unit (CPU) or a micro-processing unit (MPU). The processor 190 may be configured with a single processor or may be configured with a plurality of processors. Further, the processor 190 may be configured with an SoC integrated with a part or all of the storage 180 or other circuits. Further, the processor 190 may be implemented with a combination of a CPU that executes a program and a digital signal processor (DSP) that executes predetermined arithmetic processing. Further, a configuration in which all functions of the processor 190 are implemented in hardware may be adopted, or a configuration using a programmable device may be adopted.

### 3. Configuration of Terminal Apparatus

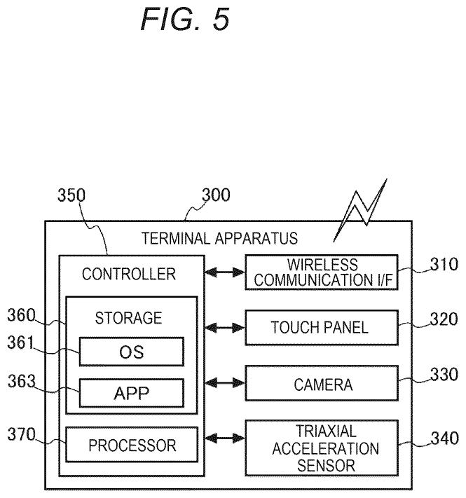

Then, a configuration of the terminal apparatus 300 will be described with reference to FIG. 5.

The terminal apparatus 300 includes a wireless communication I/F 310, a touch panel 320, a camera 330, a triaxial acceleration sensor 340, and a controller 350.

The wireless communication I/F 310 includes an interface circuit compliant with a communication standard of wireless communication such as Wi-Fi, and is connected to the network 5. The wireless communication I/F 310 performs mutual data communication with the projection apparatus 100 via the network 5. The wireless communication I/F 310 corresponds to an example of a transmitting circuit.

The touch panel 320 corresponds to an example of a display. A display panel such as a liquid crystal panel or an organic electro luminescence (EL) panel, and a touch sensor are provided. The display panel displays an image generated by the controller 350. The touch sensor is a sensor that detects a touch operation to the display panel. The touch sensor outputs, to the controller 350, a signal representing a position on the display panel touched by the user.

The camera 330 includes an image sensor such as a charge-coupled device (CCD) or a complementary metal-oxide-semiconductor (CMOS), and a data processing circuit that generates a captured image from an output of the image sensor.

The triaxial acceleration sensor 340 is a sensor that measures acceleration in three axial directions.

The controller 350 is a computer device including a storage 360 and a processor 370.

The storage 360 includes a RAM and a ROM. The RAM is used as, for example, an arithmetic area of the processor 370. The ROM stores an operating system (OS) that controls the operation of the processor 370 and application programs. The application program is hereinafter abbreviated as an APP.

The processor 370 is an arithmetic processing device including a CPU or an MPU. The processor 370 may be configured with a single processor or may be configured with a plurality of processors. Further, the processor 370 may be configured with an SoC integrated with a part or all of the storage 360 or other circuits. Further, the processor 370 may be configured with a combination of a CPU that executes a program and a DSP that executes predetermined arithmetic processing. Further, a configuration in which all functions of the processor 370 are implemented in hardware may be adopted, or a configuration using a programmable device may be adopted.

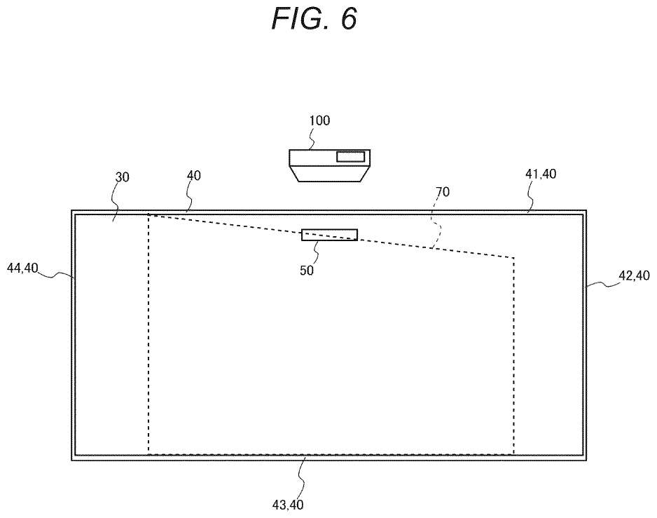

FIG. 6 is a diagram showing a shape of the projection area 70 after correction when the detection light irradiation device 50 is erroneously recognized as a part of the screen frame 40.

The projection system 1 is a system that corrects, using the terminal apparatus 300, at least one of the position and the shape of the projection area 70, which is an area in which the projection apparatus 100 can display an image on the screen 30.

The projection apparatus 100 displays a projection pattern image 90 on the screen 30, then the terminal apparatus 300 images an area including the screen 30 on which the projection pattern image 90 is displayed, and then correction parameters for correcting the shape of the projection area 70 is generated. The projection pattern image 90 includes a first projection pattern image 91 and a second projection pattern image 93 described later. On this occasion, when the detection light irradiation device 50 is installed in the screen frame 40, in some cases, the detection light irradiation device 50 may be recognized as a part of the screen frame 40, the shape of the projection area 70 may be corrected into an erroneous shape, and thus, distortion may occur also in the shape of the image projected thereon. An operation of the projection system 1 for solving such a problem will be described below.

### 4. Overall Operation

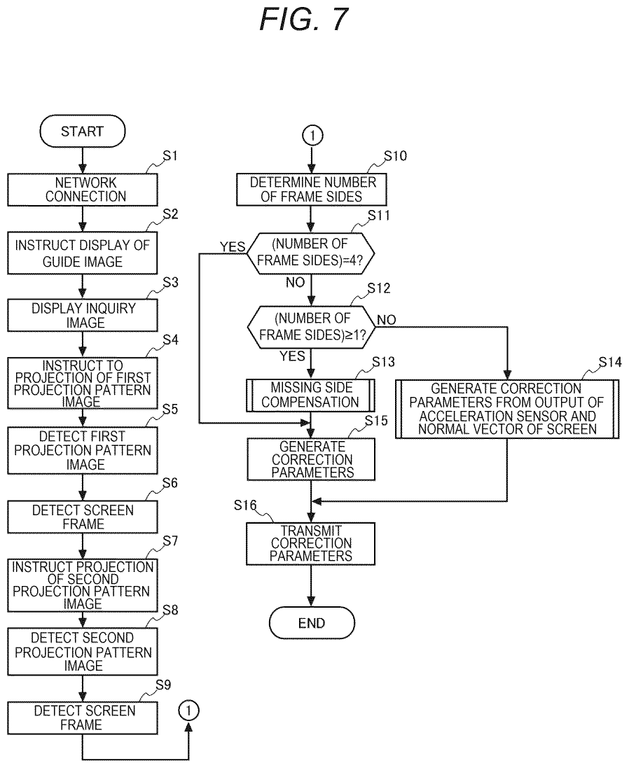

FIG. 7 is a flowchart illustrating an operation of the controller 350 of the terminal apparatus 300.

The operation of the controller 350 of the terminal apparatus 300 will be described with reference to the flowchart illustrated in FIG. 7.

First, when the APP 363 is selected by a touch operation by the user, the controller 350 executes the APP 363 thus selected to connect the terminal apparatus 300 to the network 5 (step S1). The APP 363 selected here is an application program for correcting the projection position and the shape of the projection area 70 of the projection apparatus 100.

Then, the controller 350 that executes the APP 363 instructs the projection apparatus 100 to display a guide image 80 (step S2). The projection apparatus 100 displays the guide image 80 on the screen 30 in accordance with the instruction of the terminal apparatus 300. Note that it is also possible for the projection apparatus 100 to display the guide image 80 on the screen 30 based on a determination of the projection apparatus 100 when the communication with the projection apparatus 100 via the network 5 becomes possible.

The guide image 80 may be projected in response to an operation on an operation panel of the projection apparatus 100 or an operation on an OSD (On Screen Display) menu by a remote controller, instead of an instruction from the terminal apparatus 300. In this case, the controller 350 may display, on the touch panel 320, a prompting image that prompts the user to cause the projection apparatus 100 to project the guide image 80 by an operation on the operation panel of the projection apparatus 100 or an operation on the OSD menu with the remote controller. In this case, step S2 may be omitted from the flowchart in FIG. 7, or a step of displaying the prompting image may be added to the flowchart instead of step S2.

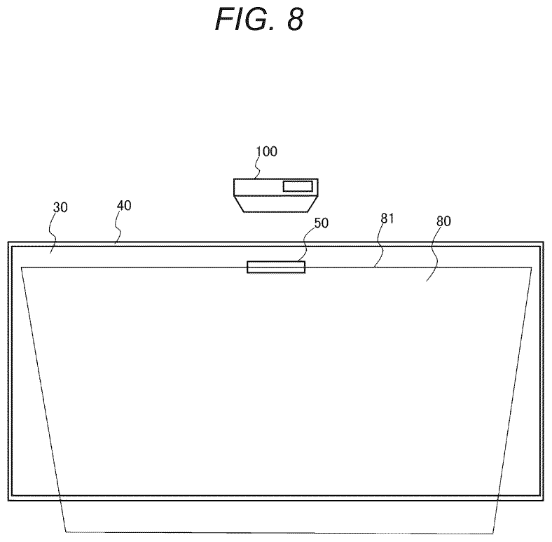

FIG. 8 is a diagram illustrating an example of the guide image 80.

The guide image 80 is an image in which a color or thickness of a guide upper side 81 of the guide image 80 is different from other sides such as a left side, a lower side, and a right side of the guide image 80. The guide upper side 81 is a side constituting an upper side of the guide image 80 in the drawing view, and is the side closest to the projection apparatus 100. On this occasion, the controller 350 may cause the touch panel 320 to display a guidance display (message) “Please adjust the adjustment mechanism so that the guide upper side 81 of the guide image 80 overlaps the detection light irradiation device 50.” Illustration of the adjustment mechanism is omitted.

The guide image 80 is not Limited to the configuration described above, and the color or the thickness of the guide upper side 81 of the guide image 80 may be the same as those of other sides such as the left side, the lower side, and the right side of the guide image 80. Further, a guidance image that guides the positional relationship between the guide upper side 81 and the detection light irradiation device 50 may be projected in the projection area 70 instead of the guide display. That guidance image is a schematic diagram showing, for example, at least a part of a procedure for adjusting the positional relationship between the guide upper side 81 and the detection light irradiation device 50 or an ideal positional relationship using a drawing or a sentence. That guidance image may be projected together with the guide image 80, or may be projected before projecting the guide image 80. When that guidance image is projected together with the guide image 80, the guidance image may be projected in an area inside the guide image 80.

The user operates the adjustment mechanism to adjust the display position of the guide image 80 such that the guide upper side 81 of the guide image 80 overlaps the detection light irradiation device 50. When the adjustment of the display position of the guide image 80 is completed, the user inputs a predetermined touch operation representing that the adjustment of the display position of the guide image 80 is completed. When the predetermined touch operation is detected, the controller 350 causes the touch panel 320 to display an inquiry image 325 (step S3).

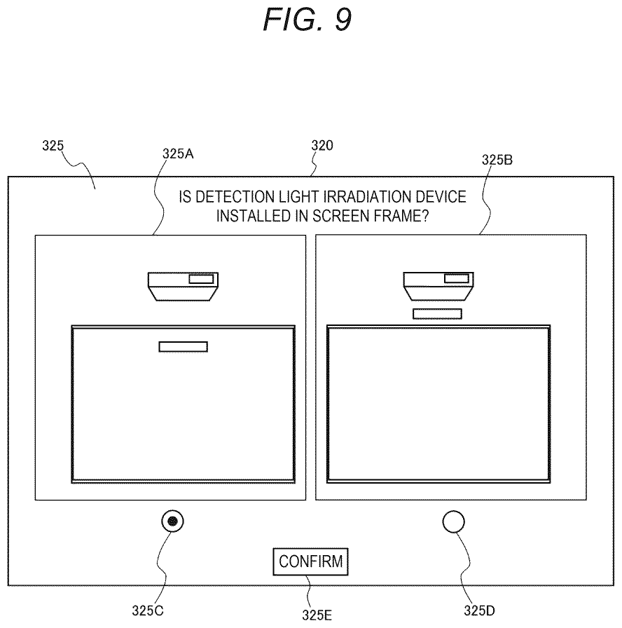

FIG. 9 is a diagram illustrating an example of the inquiry image 325.

The inquiry image 325 shown in FIG. 9 is an image displayed on the touch panel 320, but may be displayed on the screen 30 by the projection apparatus 100 as an OSD image.

The inquiry image 325 includes a schematic diagram simulating a positional relationship between the detection light irradiation device 50 and the upper frame side 41 which is an example of a first side of the screen 30.

The inquiry image 325 includes a first schematic diagram 325A, a second schematic diagram 325B, a radio button 325C, a radio button 325D, and a CONFIRM button 325E.

The first schematic diagram 325A is a diagram schematically illustrating a state in which the detection light irradiation device 50 is installed in the screen frame 40. The second schematic diagram 325B is a diagram schematically illustrating a state in which the detection light irradiation device 50 is installed outside the screen frame 40. The radio button 325C is a button to be selected when selecting the first schematic diagram 325A. The radio button 325D is a button to be selected when selecting the second schematic diagram 325B.

When the inquiry image 325 illustrated in FIG. 9 is displayed on the touch panel 320, the user selects either one of the radio button 325C and the radio button 325D and then selects the CONFIRM button 325E for determining the operation.

The configuration of selecting either one of the radio button 325C and the radio button 325D is not a limitation. For example, it is possible to omit the radio button 325C and the radio button 325D, provide the schematic diagram 325A with the function of the radio button 325C, and provide the schematic diagram 325B with the function of the radio button 325D instead. Further, the configuration of selecting the CONFIRM button 325E after the selection is not a limitation. It is possible to omit the CONFIRM button 325E, and make the transition to the next screen at the timing when either one of the radio button 325C and the radio button 325D is selected.

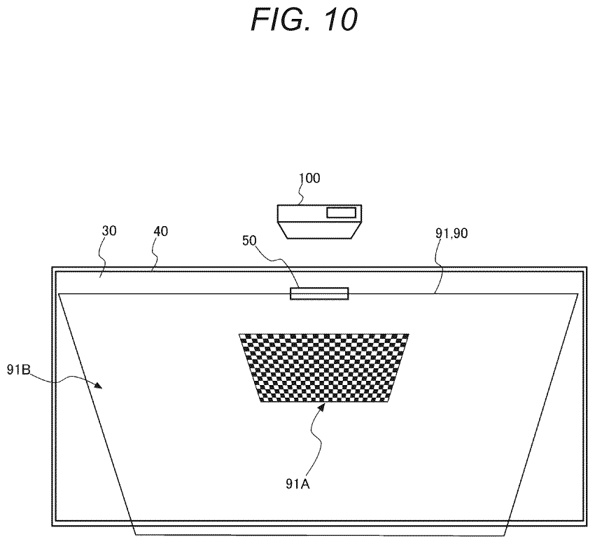

FIG. 10 is a diagram showing an example of the first projection pattern image 91 displayed on the screen 30.

When the CONFIRM button 325E in the inquiry image 325 is pressed, the controller 350 instructs the projection apparatus 100 to project the first projection pattern image 91 (step S4). The projection apparatus 100 reads image data from which the first projection pattern image 91 derives out of the storage 180 due to the instruction of the terminal apparatus 300, and outputs the image data to the image processor 120. The image processor 120 executes predetermined image processing on the image data input thereto and outputs the image data thus processed to the projector 200. The projector 200 generates image light based on the image data input thereto and projects the image light thus generated onto the screen 30.

The first projection pattern image 91 may be projected in accordance with an operation on the operation panel of the projection apparatus 100 or an operation on the OSD menu by the remote controller, instead of the instruction from the terminal apparatus 300. In this case, the controller 350 may display, on the touch panel 320, an image that prompts the user to cause the projection apparatus 100 to project the first projection pattern image 91 by an operation on the operation panel of the projection apparatus 100 or an operation on the OSD menu by the remote controller. In this case, step S4 may be omitted from the flowchart in FIG. 7, or a step of displaying that image may be added to the flowchart instead of step S4. Further, the projection apparatus 100 may have a configuration in which the projection apparatus 100 generates the first projection pattern image 91 after receiving the instruction from the terminal apparatus 300. Alternatively, it is possible to adopt a configuration in which the terminal apparatus 300 transmits the first projection pattern image 91 generated by the terminal apparatus 300 to the projection apparatus 100 via the network 5, and the projection apparatus 100 projects, onto the screen 30, the first projection pattern image 91 received from the terminal apparatus 300.

When the first projection pattern image 91 is displayed on the screen 30 by the projection apparatus 100, the user adjusts the imaging position and then presses an imaging button provided to the terminal apparatus 300.

As shown in FIG. 10, the first projection pattern image 91 includes a checker pattern 91A. The checker pattern 91A is an image in which white and black rectangular figures are alternately arranged. An area other than the checker pattern 91A of the first projection pattern image 91 is an area of a white image. This area is referred to as a white area 91B. In an initial state, what state the installation state of the projection apparatus 100 is unknown. The projection apparatus 100 displays the first projection pattern image 91 including the checker pattern 91A having a relatively small size on the screen 30 on the assumption that a central area of the first projection pattern image 91 is displayed somewhere in the screen 30.

The controller 350 acquires the captured image captured by the camera 330, and analyzes the captured image to detect the first projection pattern image 91 contained in the captured image (step S5). The controller 350 detects the checker pattern 91A contained in the captured image to thereby identify the position of the checker pattern 91A in the captured image. The controller 350 identifies the position of the checker pattern 91A in the captured image to thereby perform a coordinate association between an imaging coordinate system, which is a coordinate system set in the captured image, and a panel coordinate system, which is a coordinate system of the liquid crystal panel 230.

Then, the controller 350 detects the screen frame 40 based on a contrast ratio (step S6). The white area 91B is formed around the checker pattern 91A. The controller 350 performs image analysis from the center toward an end portion of the first projection pattern image 91 contained in the captured image to thereby detect, as the screen frame 40, a position where the contrast ratio is equal to or higher than a threshold value. The controller 350 transforms the coordinates in the imaging coordinate system thus detected into coordinates in the panel coordinate system to thereby identify the coordinates of the screen frame 40 in the panel coordinate system.

Then, the controller 350 instructs the projection apparatus 100 to project the second projection pattern image 93 (step S7). The projection apparatus 100 reads image data from which the second projection pattern image 93 derives out of the storage 180 due to the instruction of the terminal apparatus 300, and outputs the image data to the image processor 120. The image processor 120 executes predetermined image processing on the image data input thereto and outputs the image data thus processed to the projector 200. The projector 200 generates image Light based on the image data input thereto and projects the image light thus generated onto the screen 30.

The second projection pattern image 93 may be projected in accordance with an operation on the operation panel of the projection apparatus 100 or an operation on the OSD menu the remote controller, instead of the instruction from the terminal apparatus 300. In this case, the controller 350 may display, on the touch panel 320, an image that prompts the user to cause the projection apparatus 100 to project the second projection pattern image 93 by an operation on the operation panel of the projection apparatus 100 or an operation on the OSD menu by the remote controller. In this case, step S7 may be omitted from the flowchart in FIG. 7, or a step of displaying that image may be added to the flowchart instead of step S7. Further, similarly to the case of step S4, the projection apparatus 100 may be configured such that the projection apparatus 100 generates the second projection pattern image 93 after receiving the instruction from the terminal apparatus 300. Alternatively, it is possible to adopt a configuration in which the terminal apparatus transmits the second projection pattern image 93 generated by the terminal apparatus 300 to the projection apparatus 100 via the network 5, and the projection apparatus 100 projects, onto the screen 30, the second projection pattern image 93 received from the terminal apparatus 300.

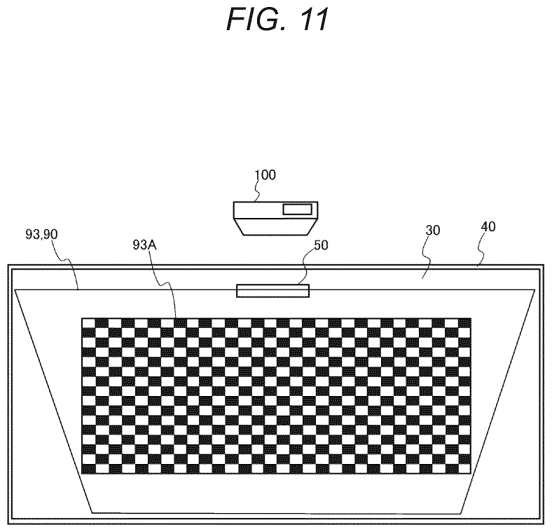

FIG. 11 is a diagram showing an example of the second projection pattern image 93 displayed on the screen 30. Similarly to the first projection pattern image 91, the second projection pattern image 93 also includes a checker pattern 93A. In the present embodiment, the size of the white and black rectangles constituting the checker pattern 93A is the same as the size of the white and black rectangles constituting the checker pattern 91A. In the second projection pattern image 93, the checker pattern 93A is displayed on the screen 30 in a large size such that the distance between the checker pattern 93A and the screen frame 40 is as short as possible. That is, a display range of the checker pattern 93A in the second projection pattern image 93 is larger than a display range of the checker pattern 91A in the first projection pattern image 91. By shortening the distance between an outer edge of the checker pattern 93A and the screen frame 40, it becomes possible to use the checker pattern around the screen frame 40, and thus, an influence of distortion of an imaging lens is suppressed to improve the accuracy of conversion of the position of the screen frame 40 in the imaging coordinate system into the position in the panel coordinate system. In the present embodiment, the display range of the checker pattern 93A is determined based on the position of the screen frame 40 in the panel coordinate system identified based on the checker pattern 91A. Note that geometric correction based on the correspondence relationship between the imaging coordinate system and the panel coordinate system identified based on the checker pattern 91A may optionally be performed on the checker pattern 93A.

When the second projection pattern image 93 is displayed on the screen 30 by the projection apparatus 100, the user adjusts the imaging position and then presses the imaging button provided to the terminal apparatus 300.

The controller 350 acquires the captured image captured by the camera 330, and analyzes the captured image to detect the second projection pattern image 93 contained in the captured image (step S8). The controller 350 detects the checker pattern 93A contained in the captured image to thereby identify the position of the checker pattern 93A in the captured image. Then, the controller 350 performs once again the coordinate association between the imaging coordinate system, which is the coordinate system set in the captured image, and the panel coordinate system, which is the coordinate system of the liquid crystal panel 230.

Similarly, the controller 350 executes detection processing of detecting the screen frame 40 from the captured image (step S9). The controller 350 performs image analysis from the center toward an end portion of the second projection pattern image 93 contained in the captured image to thereby detect, as the screen frame 40, a position where the contrast ratio is equal to or higher than a threshold value.

Then, the controller 350 determines the number of frame sides of the screen frame 40 thus detected (step S10). Here, even when the number of frame sides of the screen frame 40 detected by the controller 350 is four, when the radio button 325C has been selected in step S3, it is determined that the number of frame sides of the screen frame 40 is not four. That is, when the radio button 325D is selected in step S3 and the controller 350 detects the four frame sides of the screen frame 40, the determination in step S10 becomes affirmative.

When the number of frame sides of the screen frame 40 thus detected is four (YES in step S11), the controller 350 generates correction parameters for correcting the position and the shape of the projection area 70 so that the projection area 70 fits within the screen frame 40 thus detected (step S15).

Subsequently, the controller 350 transmits the correction parameters thus generated to the projection apparatus 100 via the wireless communication I/F 310 (step S16). When the projection apparatus 100 receives the correction parameters through the wireless communication I/F 110, the image processor 120 corrects the image data based on the correction parameters thus received to output the image data thus corrected to the projector 200. The projector 200 generates image light based on the image data input thereto and projects the image light thus generated onto the screen 30.

Further, when the number of frame sides of the screen frame 40 thus detected is not four (NO in step S11), the controller 350 determines whether one or more frame sides of the screen frame 40 are detected by the detection processing of the screen frame 40 executed in step S9 (step S12).

When one or more frame sides of the screen frame 40 are detected by the detection processing (YES in step S12), the controller 350 executes missing side compensation processing of compensating a missing side of the screen frame 40 that has failed to be detected (step S13).

Here, when the radio button 325C has been selected in step S3, the controller 350 invalidates a detection result of an upper side 510 and compensates the upper side 510 which is the missing side. Subsequently, the controller 350 generates the correction parameters for correcting the position and the shape of the projection area 70 so that the projection area 70 falls within the screen frame 40 configured with the four frame sides detected and compensated by the detection processing and the missing side compensation processing (step S15). The correction parameters generated here correspond to an example of a first correction value. Further, sides other than the upper side 510 correspond to a second side.

Further, when the radio button 325D has been selected in step S3 and the upper side 510 has been detected, the detection result of the upper side 510 is not invalidated. When any of the sides other than the upper side 510 has not been detected, the controller 350 executes the missing side compensation processing to compensate the missing side. Subsequently, the controller 350 generates the correction parameters for correcting the position and the shape of the projection area 70 so that the projection area 70 falls within the screen frame 40 configured with the four frame sides detected and compensated by the detection processing and the missing side compensation processing (step S15). The correction parameters generated here correspond to an example of a second correction value. The upper side 510 corresponds to a first side, and the sides other than the upper side 510 correspond to the second side.

Subsequently, the controller 350 transmits the correction parameters thus generated to the projection apparatus 100 via the wireless communication I/F 310 (step S16).

Further, when no frame side of the screen frame 40 can be detected by the detection processing of the screen frame 40 executed in step S9 (NO in step S12), the controller 350 proceeds to step S14. In step S14, the controller 350 generates the correction parameters for correcting the shape of the projection area 70 from the output of the triaxial acceleration sensor 340 and a normal vector of the screen 30. Subsequently, the controller 350 transmits the correction parameters thus generated to the projection apparatus 100 (step S16).

### 5. Operation When Only Lower Side of Screen Frame Is Detected

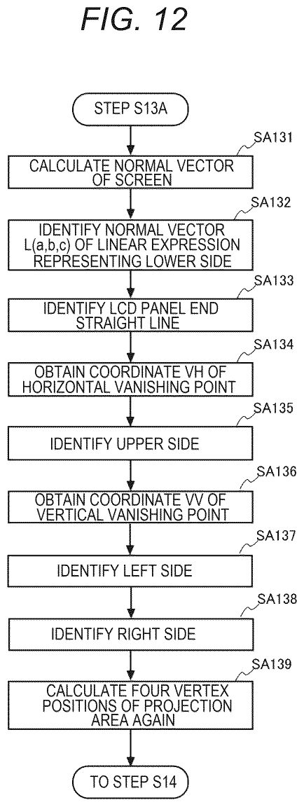

FIG. 12 is a flowchart showing processing operations in the missing side compensation processing when only the lower frame side 43 out of the four sides constituting the screen frame 40 is detected from the captured image.

Then, operations of the controller 350 when only the lower frame side 43 of the screen frame 40 is detected will be described.

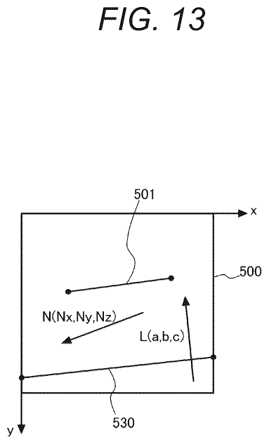

FIGS. 13 to 17 are diagrams illustrating the missing side compensation processing, and are diagrams illustrating a normalized panel coordinate system obtained by normalizing the panel coordinate system of the liquid crystal panel 230. The rectangular figures illustrated in FIGS. 13 to 17 represent a panel region 500 of the liquid crystal panel 230 in the normalized panel coordinate system.

FIG. 13 is a diagram illustrating an upper side 501 and a lower side 530 of the screen frame 40 detected from the captured image and the normal vector N of the screen 30. The upper side 501 and the lower side 530 respectively represent an upper side and a lower side in the normalized panel coordinate system. Here, the upper side 501 is data obtained by erroneously detecting the detection light irradiation device 50 as a part of an upper side of the screen 30.

First, the controller 350 calculates the normal vector of the screen 30. The normal vector of the screen 30 thus calculated is referred to as N(nx, ny, nz) (step SA131).

Then, the controller 350 obtains values of a normal vector L(a, b, c) of the lower side 530 by substituting the coordinate values of the lower side 530 detected in step S9 illustrated in FIG. 7 into the following linear expression representing the lower side 530 (step SA132).

$$ax + by + c = 0$$

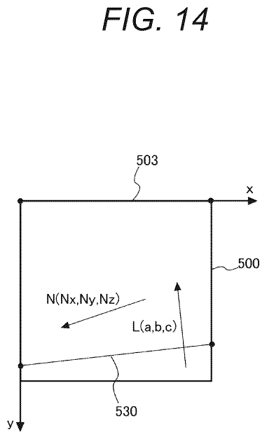

FIG. 14 is a diagram showing an LCD panel end straight line 503.

When the radio button 325C is selected in step S3, the controller 350 invalidates the detection result of the upper side 501. The controller 350 invalidates the detection result of the upper side 501 and identifies the LCD panel end straight line 503 in the normalized panel coordinate system (step SA133).

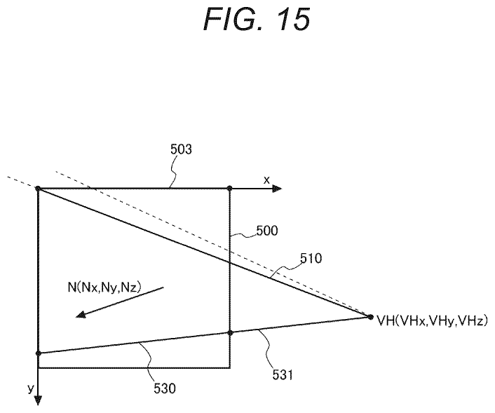

FIG. 15 is a diagram illustrating a horizontal vanishing point VH.

Then, the controller 350 obtains a cross product of the normal vector N(nx, ny, nz) and a normal vector L(a, b, c) of the lower side 530 to obtain coordinates (VHx, VHy, VHz) of the horizontal vanishing point VH (step SA134). In FIG. 15, a side obtained by extending the lower side 530 to the horizontal vanishing point VH is illustrated as a side 531.

Then, the controller 350 identifies the upper side 510 (step SA135). The controller 350 identifies, as the upper side 510, the innermost straight line in a group of straight lines passing through the LCD panel end straight line 503 and the horizontal vanishing point VH (step SA135). The controller 350 identifies a straight line passing through a left end of the LCD panel end straight line 503 as the upper side 510 in the drawing view.

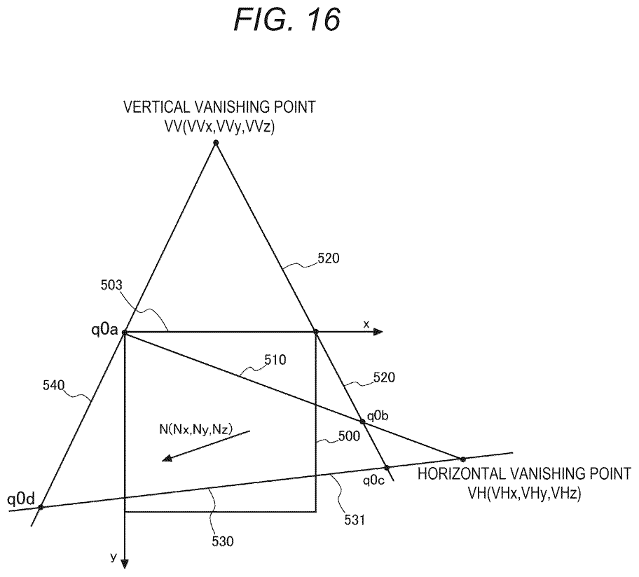

FIG. 16 is a diagram illustrating a vertical vanishing point VV.

Then, the controller 350 obtains a cross product of the normal vector N(nx, ny, nz) and the horizontal vanishing point VH(VHx, VHy, VHz) to obtain coordinates (VVx, VVy, VVz) of the vertical vanishing point VV (step SA136).

Then, the controller 350 identifies, as a left side 540, the innermost straight line of a group of straight lines passing through the vertical vanishing point W and the LCD panel end straight line 503 (step SA137). The controller 350 identifies a straight line passing through the left end of the LCD panel end straight line 503 as the left side 540 in the drawing view.

Then, the controller 350 identifies, as a right side 520, the innermost straight line of the group of the straight lines passing through the vertical vanishing point VV and the LCD panel end straight line 503 (step SA138). The controller 350 identifies a straight line passing through a right end of the LCD panel end straight line 503 as the right side 520 in the drawing view.

Then, the controller 350 calculates once again the positions of the four vertices constituting the screen frame 40 (step SA139). The controller 350 executes step SA139 in order to fit the shape thus corrected within the panel region (maximum resolution) 500. That is, since there is a concern that the straight line may protrude from the panel region 500 due to a calculation error or the like only by identifying the innermost straight line in step SA135 and so on, the controller 350 executes step SA139 to thereby improve the accuracy in fitting the shape thus corrected.

The controller 350 obtains four intersections of the upper side 510, the right side 520, the lower side 530, and the left side 540 thus identified as four vertices q0a, q0b, q0c, and q0d of the screen frame 40.

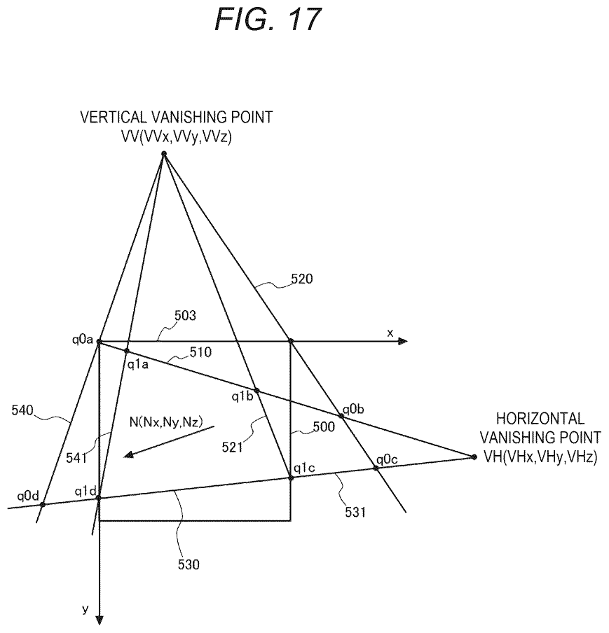

As shown in FIG. 16, there is a possibility that the four vertices q0a, q0b, q0c, and god of the screen frame 40 protrude from the projection area 70. Therefore, the controller 350 adjusts the positions of the four vertices q0a, q0b, q0c, and q0d so that the vertex that protrudes therefrom is located within the panel region 500. In an example illustrated in FIG. 17, since the vertices q0c and q0d are outside the panel region 500, the positions of the vertices q0c and q0d are moved along the lower side 530 to positions of vertices q1c and q1d, respectively.

Note that, for example, the step of identifying the innermost straight line as the upper side 510 in step SA135 may collectively be executed in step SA139 by the controller 350.

FIG. 17 shows lines drawn from the horizontal vanishing point VH and the vertical vanishing point VV toward the four vertices q0a, q0b, q1c, and q1d thus adjusted.

Then, the controller 350 draws straight lines toward the four vertices q0a, q0b, q1c, and q1d thus adjusted.

A straight line passing through the vertical vanishing point VV and the vertex q1c is referred to as a right side 521.

A straight line passing through the vertical vanishing point VV and the vertex q1d is referred to as a left side 541.

An intersection of the right side 521 and the upper side 510 is defined as a vertex q1b. Further, an intersection of the left side 541 and the upper side 510 is defined as a vertex q1a.

The controller 350 identifies the four vertices q1a, q1b, q1c, and q1d as frame vertices after the compensation. That is, an area zoned by the upper side 510, the right side 521, the lower side 530, and the left side 541 is identified as the screen frame 40.

### 6. Operation When Upper Side And Lower Side of Screen Frame Are Detected

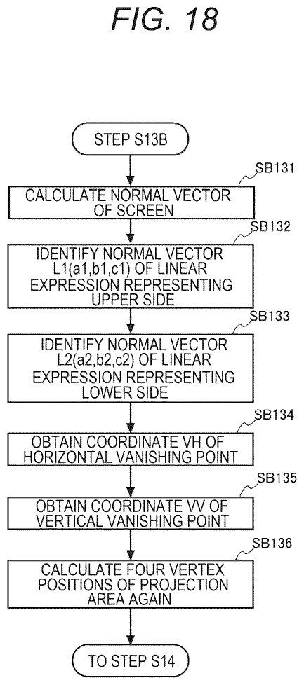

FIG. 18 is a flowchart showing a processing operations in the missing side compensation processing when the upper side 510 and the lower side 530 out of the four sides constituting the screen frame 40 are detected.

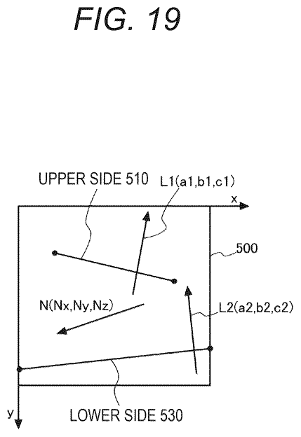

FIGS. 19 to 21 are diagrams illustrating the missing side compensation processing, and are diagrams illustrating the normalized panel coordinate system obtained by normalizing the panel coordinate system of the liquid crystal panel 230. The rectangular figures illustrated in FIGS. 19 to 21 represent the panel region 500 of the liquid crystal panel 230 in the normalized panel coordinate system.

FIG. 19 is a diagram illustrating the upper side 510 and the lower side 530 of the screen frame 40 detected from the captured image and the normal vector N of the screen 30. The upper side 510 and the lower side 530 are the upper side 501 and the lower side 530 in the normalized panel coordinate system.

First, the controller 350 calculates the normal vector of the screen 30. The normal vector of the screen 30 thus calculated is referred to as N(nx, ny, nz) (step SB131).

Then, the controller 350 obtains values of a normal L1(a1, b1, c1) of the upper side 510 by substituting the coordinate values of the upper side 510 detected in step S9 illustrated in FIG. 7 into the following linear expression representing the upper side 510 (step SB132).

$$a 1 x + b 1 y + c 1 = 0$$

Then, the controller 350 obtains values of a normal vector L2(a2, b2, c2) of the lower side 530 by substituting the coordinate values of the lower side 530 detected in step S9 illustrated in FIG. 7 into the following linear expression representing the lower side 530 (step SB133).

$$a 2 x + b 2 y + c 2 = 0$$

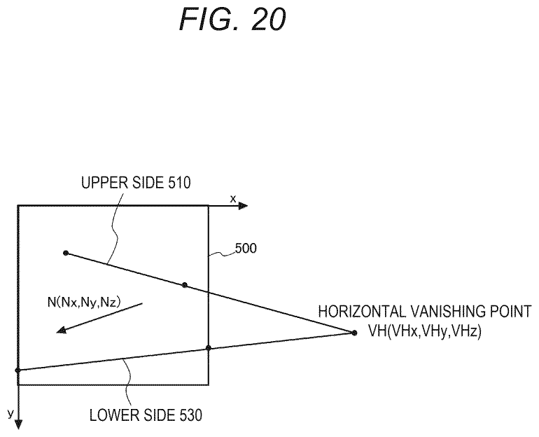

FIG. 20 is a diagram illustrating the horizontal vanishing point VH.

Then, the controller 350 obtains the coordinates of the horizontal vanishing point VH.

The controller 350 obtains the horizontal vanishing point VH which is an intersection of the linear expression of the upper side 510 calculated in step S132B and the linear expression of the lower side 530 calculated in step S133B (step SB134). Specifically, the coordinates of the horizontal vanishing point VH are obtained from a cross product of the normal vector L1(a1, b1, c1) of the upper side 510 and the normal vector L2(a2, b2, c2) of the lower side 530. In the normalized panel coordinate system, the property that the coordinates of the horizontal vanishing point VH are obtained by obtaining a cross product of the normal vectors of the linear expressions is used.

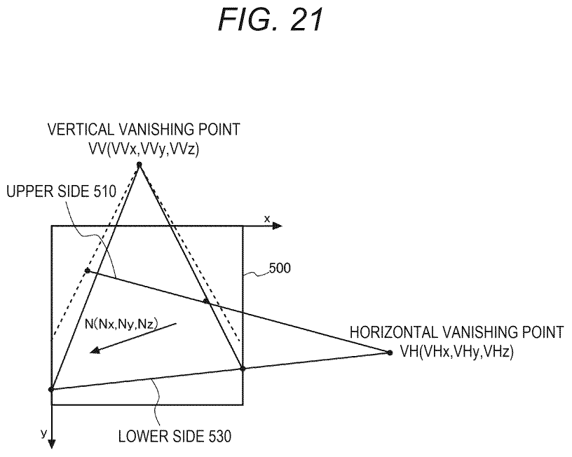

FIG. 21 is a diagram illustrating a vertical vanishing point VV.

Then, the controller 350 obtains the vertical vanishing point VV (step SB135).

The controller 350 obtains the vertical vanishing point W from a cross product of the normal vector N(nx, ny, nz) of the screen 30 and the normal vector L2(a2, b2, c2) of the lower side 530.

Then, the controller 350 calculates once again the four vertex positions of the projection area 70 similarly to step SA139 in the flowchart shown in FIG. 12. The controller 350 executes step SA139 in order to fit the shape thus corrected within the panel region (maximum resolution) 500. That is, since there is a concern that the straight line may protrude from the panel region 500 due to a calculation error or the like only by identifying the innermost straight line in step SA135 and so on, the controller 350 executes step SA139 to thereby improve the accuracy in fitting the shape thus corrected. Since this processing operation is the same as in step SA139 described with reference to FIG. 17, detailed description thereof will be omitted. Here, for example, the step of identifying the innermost straight line as the upper side 510 in step SA135 may collectively be executed in step SA139 by the controller 350.

### 7. Operation When Upper Side And Left Side of Screen Frame Are Detected

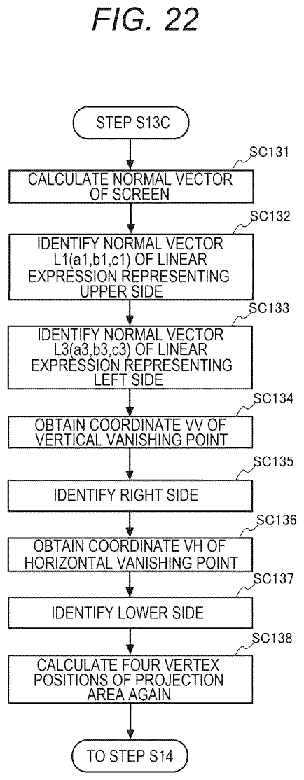

FIG. 22 is a flowchart showing a processing operations in the missing side compensation processing when the upper side 510 and the left side 540 out of the four sides constituting the screen frame 40 are detected.

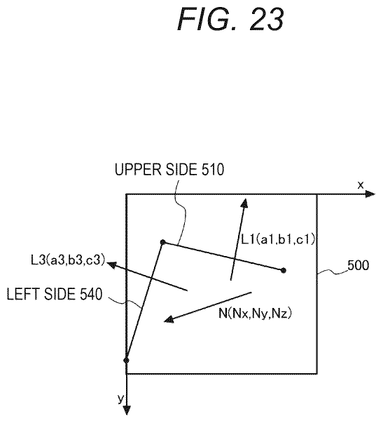

FIGS. 23 to 27 are diagrams illustrating the missing side compensation processing, and are diagrams illustrating the normalized panel coordinate system obtained by normalizing the panel coordinate system of the liquid crystal panel 230. The rectangular figures illustrated in FIGS. 23 to 27 represent the panel region 500 of the liquid crystal panel 230 in the normalized panel coordinate system.

FIG. 23 is a diagram showing the normal vector N(nx, ny, nz) of the screen 30 and the upper side 510 and the left side 540 of the screen frame 40 thus detected.

First, the controller 350 calculates the normal vector of the screen 30. The normal vector of the screen 30 thus calculated is referred to as N(nx, ny, nz) (step SC131).

Then, the controller 350 obtains values of the normal vector L1(a1, b1, c1) of the upper side 510 by substituting the coordinate values of the upper side 510 detected in step S9 illustrated in FIG. 7 into the following linear expression representing the upper side 510 (step SC132).

$$a 1 x + b 1 y + c 1 = 0$$

Then, the controller 350 obtains values of a normal vector L3(a3, b3, c3) of the left side 540 by substituting the coordinate values of the left side 540 detected in step S9 illustrated in FIG. 7 into the following linear expression representing the left side 540 (step SC133).

$$a 3 x + b 3 y + c 3 = 0$$

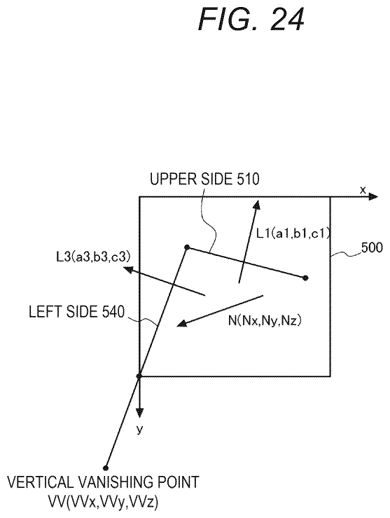

FIG. 24 is a diagram illustrating the coordinates of the vertical vanishing point WV.

Then, the controller 350 obtains the coordinates of the vertical vanishing point W (step SC134).

The controller 350 obtains a cross product of the normal vector L3(a3, b3, c3) of the left side 540 and the normal vector N(nx, ny, nz) of the screen 30 to thereby obtain the coordinates (VVx, VVy, VVz) of the vertical vanishing point VV.

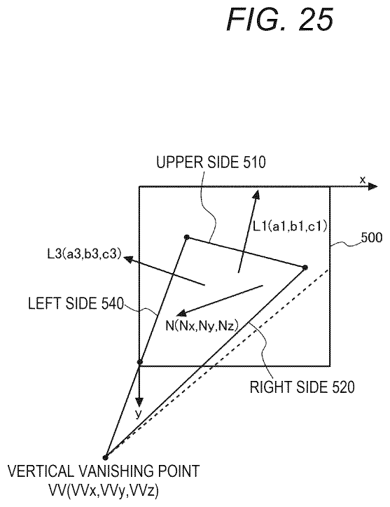

FIG. 25 is a diagram illustrating the right side 520 of the screen frame 40.

Then, the controller 350 identifies the right side 520 of the screen frame 40 (step SC135). The controller 350 identifies, as the right side 520, the innermost straight line in a group of straight lines passing through the vertical vanishing point VV obtained in step SC134 and the upper side 510. The controller 350 identifies a straight line passing through the right end of the upper side 510 as the right side 520 in the drawing view.

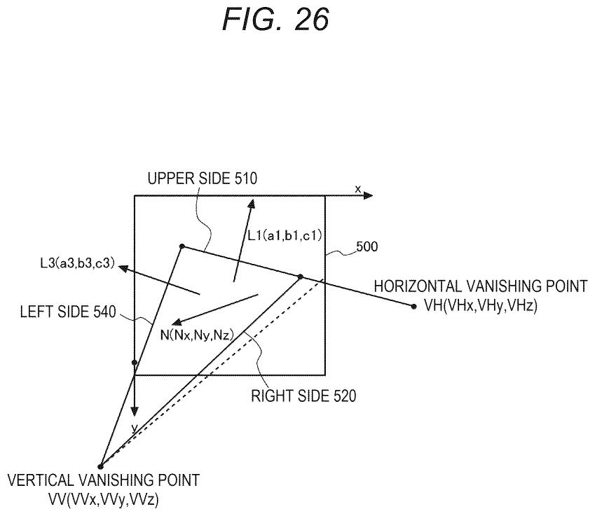

FIG. 26 is a diagram illustrating the horizontal vanishing point VH.

Then, the controller 350 obtains the coordinates of the horizontal vanishing point VH (step SC136).

The controller 350 obtains the cross product of the normal vector L1(a1, b1, c1) of the upper side 510 and the normal vector N(nx, ny, nz) of the screen 30 to thereby obtain the coordinates (VHx, VHy, VHz) of the horizontal vanishing point VH.

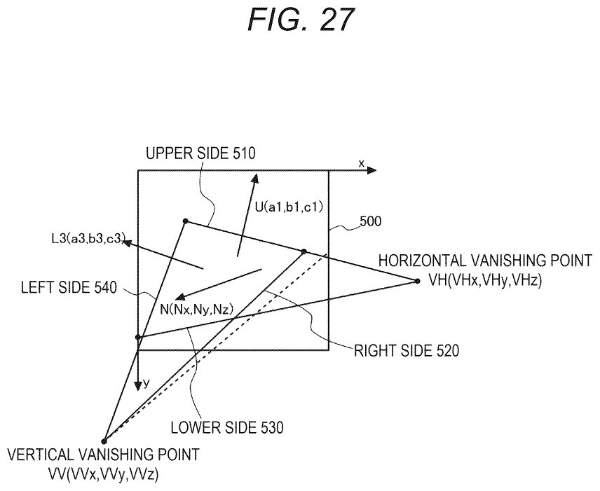

FIG. 27 is a diagram illustrating the lower side of the screen frame 40.

Then, the controller 350 identifies the lower side 530 of the screen frame 40 (step SC137). The controller 350 identifies, as the lower side 530, the innermost straight line out of the straight lines passing through the horizontal vanishing point VH obtained in step SC135 and the left side 540.

Subsequently, the controller 350 calculates once again the four vertex positions of the projection area 70 similarly to step SA139 in the flowchart shown in FIG. 12. The controller 350 executes step SA139 in order to fit the shape thus corrected within the panel region (maximum resolution) 500. That is, since there is a concern that the straight line may protrude from the panel region 500 due to a calculation error or the like only by identifying the innermost straight line in step SA135 and so on, the controller 350 executes step SA139 to thereby improve the accuracy in fitting the shape thus corrected. Since this processing operation is the same as in step SA139 described with reference to FIG. 17, detailed description thereof will be omitted. Here, for example, the step of identifying the innermost straight line as the upper side 510 in step SA135 may collectively be executed in step SA139 by the controller 350.

In the flowchart illustrated in FIG. 22, when the upper side 510 and the left side 540 of the screen 30 are detected has been described as an example, but when the lower side 530 and the right side 520 of the screen 30 are detected can also be processed in substantially the same manner. Changes in the processing operations when the lower side 530 and the right side 520 are detected will be described.

In step SC133, processing of obtaining a normal vector of a linear expression representing the right side is executed.

In step SC134, processing of obtaining the coordinates (VHx, VHy, VHz) of the horizontal vanishing point VH is executed. The coordinates (VHx, VHy, VHz) of the horizontal vanishing point VH are obtained by obtaining a cross product of the normal vector of the right side 520 and the normal vector of the screen 30.

In step SC135, processing of identifying the left side is executed. The left side 540 is identified from a group of straight lines passing through the horizontal vanishing point VH and the lower side 530.

In step SC136, the processing of obtaining the coordinates (WVx, WVy, WVz) of the vertical vanishing point VV is executed. The coordinates (VVx, VVy, VVz) of the vertical vanishing point VV are obtained by obtaining a cross product of the normal vector of the lower side 530 and the normal vector of the screen 30.

In step SC137, processing of identifying the upper side 510 is executed. The upper side 510 is identified from a group of straight lines passing through the vertical vanishing point VV and the right side 520.

### 8. Detailed Flow of Step S14

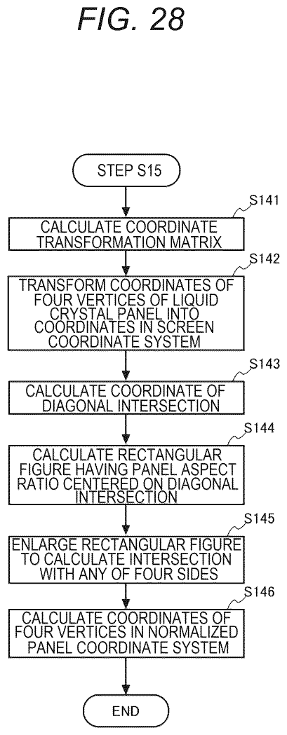

FIG. 28 is a flowchart showing details of step S14 in the flowchart shown in FIG. 7. Details of step S14 will be described with reference to the flowchart shown in FIG. 28.

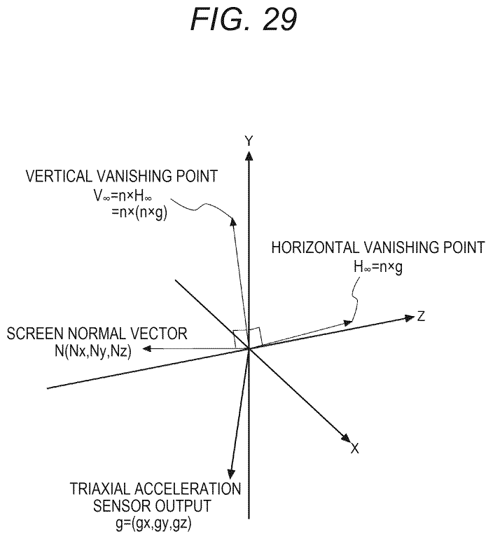

FIG. 29 is a diagram illustrating an output of the triaxial acceleration sensor, the normal vector of the screen 30, the vertical vanishing point, and the horizontal vanishing point. The X, Y, and Z axes illustrated in FIG. 29 represent three axis directions orthogonal to each other, wherein the Y axis is parallel to the vertical direction, and each of the X axis and the Z axis is parallel to horizontal directions.

First, the controller 350 obtains a coordinate transformation matrix for transforming the normalized panel coordinate system into the screen coordinate system (step S141). A matrix having the horizontal vanishing point, the vertical vanishing point, and the normal vector of the screen 30 as components is the coordinate transformation matrix. Here, the property that a cross product of the gravitational direction detected by the triaxial acceleration sensor and the normal vector of the screen 30 becomes the X-axis direction of the roll-compensated screen coordinate system is used.

The normal vector of the screen 30 is defined as N(nx, ny, nz), and a vector in the gravitational direction output from the triaxial acceleration sensor is defined as (gx, gy, gz).

The normal vector N(nx, ny, nz) of the screen 30 and the vector (gx, gy, gz) in the gravitational direction are values in a local coordinate system of the projection apparatus 100 configured with the optical axis of the projection lens of the projection apparatus 100 and two axes orthogonal to the optical axis taking the center of the projection lens as the origin. The vector (gx, gy, gz) in the gravitational direction output by the triaxial acceleration sensor is output as a value in the local coordinate system of the triaxial acceleration sensor, but the value of the vector (gx, gy, gz) in the gravitational direction is converted into the local coordinate system of the projection apparatus 100 based on an assembling positional relationship between the triaxial acceleration sensor and the projection lens.

The horizontal vanishing point in a homogeneous normalized coordinate system is obtained by the following formula (1) with the cross product of the normal vector N(nx, ny, nz) of the screen 30 and the output (gx, gy, gz) of the triaxial acceleration sensor.

$$\begin{matrix}( {H}_{x} , {H}_{y} , {H}_{z} ) = ( {n}_{x} , {n}_{y} , {n}_{z} ) \times ( {g}_{x} , {g}_{y} , {g}_{z} ) \\ = ( {n}_{y} {g}_{z} - {n}_{z} {g}_{y} , {n}_{z} {g}_{x} - {n}_{x} {g}_{z} , {n}_{x} {g}_{y} - {n}_{y} {g}_{x} )\end{matrix} \qquad ( 1 )$$

Further, the vertical vanishing point in the homogeneous normalized coordinate system is obtained by the following formula (2) with a cross product of the normal vector N(nx, ny, nz) of the screen 30 and the horizontal vanishing point in the homogeneous normalized coordinate system obtained by the formula (1).

$$\begin{matrix}( {V}_{x} , {V}_{y} , {V}_{z} ) = ( {n}_{x} , {n}_{y} , {n}_{z} ) \times ( {H}_{x} , {H}_{y} , {H}_{z} ) \\ = ( {n}_{y} {H}_{z} - {n}_{z} {H}_{y} , {n}_{z} {H}_{x} - {n}_{x} {H}_{z} , {n}_{x} {H}_{y} - {n}_{y} {H}_{x} )\end{matrix} \qquad ( 2 )$$

Since the matrix having the horizontal vanishing point, the vertical vanishing point, and the normal vector of the screen 30 as the components functions as a coordinate transformation matrix for transforming the normalized panel coordinate system into the screen coordinate system, the coordinate transformation matrix is expressed by the following formula (3).

$${H}_{p} = ( \begin{matrix}{H}_{x} & {H}_{y} & {H}_{z} \\ {V}_{x} & {V}_{y} & {V}_{z} \\ {n}_{x} & {n}_{y} & {n}_{z}\end{matrix} ) \qquad ( 3 )$$

Then, the controller 350 transforms the coordinates of the four vertices of the liquid crystal panel 230 into the coordinates of the four vertices in the screen coordinate system using the coordinate transformation matrix (3) described above (step S142).

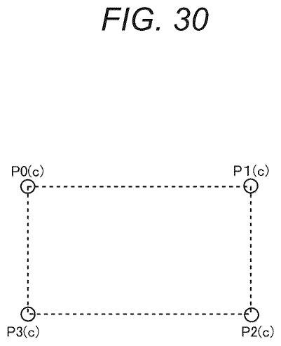

FIG. 30 is a diagram showing the four vertices of the liquid crystal panel 230 in the normalized panel coordinate system. The coordinates of the four vertices of the liquid crystal panel 230 in the normalized panel coordinate system are denoted by p0(c), p1(c), p2(c), and p3(c), respectively. The character “c” in the parentheses represents that the coordinate is a coordinate in the normalized panel coordinate system.

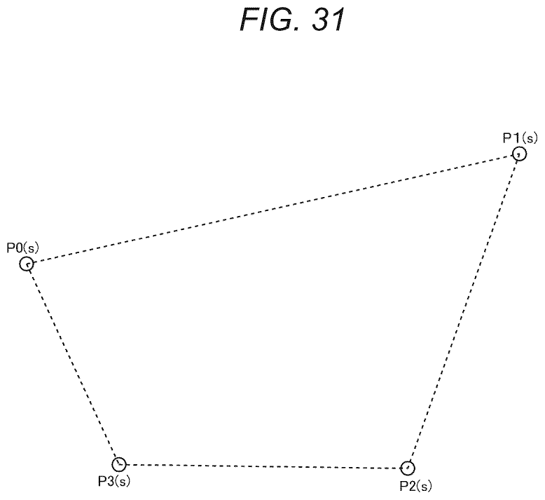

Further, FIG. 31 is a diagram illustrating coordinates p0(s), p1(s), p2(s), and p3(s) of the four vertices in the screen coordinate system after the transformation. The character “s” in the parentheses represents that the coordinate is a coordinate in the screen coordinate system.

Then, the controller 350 obtains a coordinate of an intersection Q of diagonals of the coordinates of the four vertices of the screen coordinate system thus transformed (step S143).

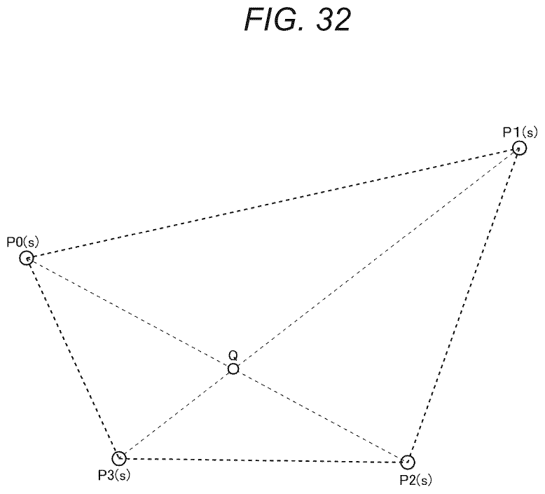

FIG. 32 is a diagram illustrating the intersection Q of diagonal lines of a quadrangle 620 formed by the four vertices p0(s), p1(s), p2(s), and p3(s).

Then, the controller 350 calculates a rectangular FIG. 610 having the aspect ratio of the liquid crystal panel 230 centered on the intersection Q of the diagonal lines (step S144). Then, the controller 350 enlarges the rectangular FIG. 610 while keeping the aspect ratio to search for an intersection between the rectangular figure 610 and the quadrangle 620. That is, the controller 350 searches for the intersection with the quadrangle 620 the closest to the intersection Q of the diagonal lines.

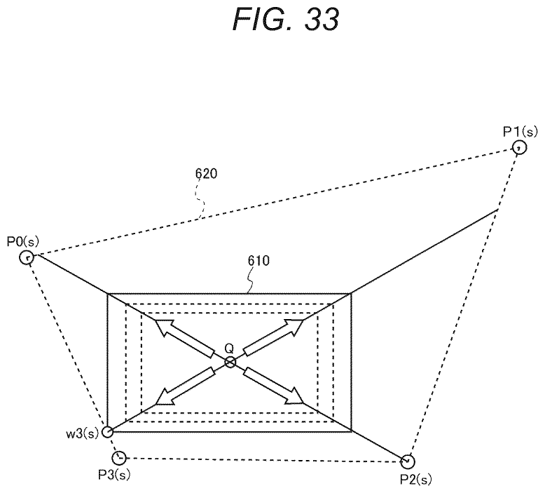

FIG. 33 is a diagram illustrating the rectangular figure 610 after the enlargement.

Then, the controller 350 enlarges the rectangular figure 610 to obtain an intersection with the quadrangle 620 configured with the four vertices p0(s), p1(s), p2(s), and p3(s) (step S145). The controller 350 enlarges the rectangular FIG. 610 having the aspect ratio of the liquid crystal panel 230 centered on the intersection Q of the diagonal lines thus obtained while keeping the aspect ratio to obtain the intersection with the quadrangle 620 configured with the four vertices p0(s), p1(s), p2(s), and p3(s). The intersection thus obtained is defined as an intersection w3(s).

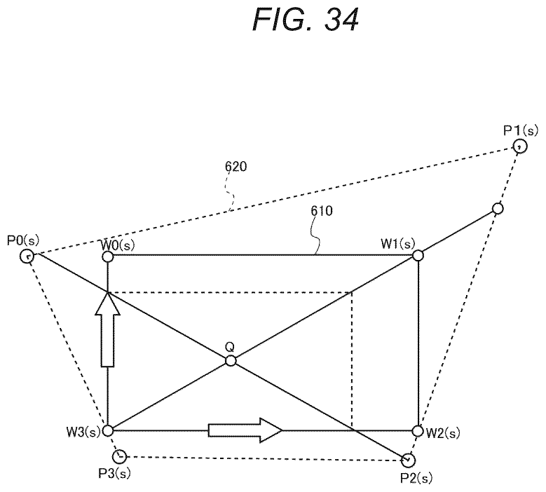

FIG. 34 is a diagram illustrating the rectangular FIG. 610 after the enlargement.

Upon detection of the intersection w3(s) with the quadrangle 620, the controller 350 further enlarges the rectangular figure 610 while keeping the aspect ratio. On this occasion, the controller 350 increases the size of the rectangular figure 610 without changing the position of the intersection w3(s) thus detected with the quadrangle 620. Then, the controller 350 obtains another intersection between the rectangular figure 610 thus enlarged and the quadrangle 620. This intersection is denoted by w2(s).

Further, the controller 350 defines other vertices of the rectangular figure 610 than the intersections w3(s) and w2(s) respectively as w0(s) and w1(s). The controller 350 transforms the coordinates in the screen coordinate system of w0(s), w1(s), w2(s), and w3(s) into coordinates in the normalized panel coordinate system with an inverse matrix of the coordinate transformation matrix (3) (step S146).

### 9. Other Embodiments

The present embodiment described above is a preferred embodiment. However, the embodiment described above is not a limitation, and various modified implementations can be made without departing from the scope and spirit of the present disclosure.

For example, in the embodiment described above, there is described when the controller 350 of the terminal apparatus 300 that executes the APP 363 generates the correction parameters, but the generation of the correction parameters may be performed by the projection apparatus 100. Further, regarding the camera, the camera 155 provided to the projection apparatus 100 can be used, the camera 330 provided to the terminal apparatus 300 can be used, or a configuration in which a camera is separately provided independently of the projection apparatus 100 or the terminal apparatus 300 can be adopted.

Further, although 9 FIG. illustrates the inquiry image 325 for inquiring whether the detection light irradiation device 50 is located in the area inside the screen frame 40 or the area outside the screen frame 40, the inquiry image 325 may include a guidance for inquiring the presence or absence of the detection light irradiation device 50 itself.

Further, the position of the detection light irradiation device 50 is not limited only to the upper frame side 41 of the screen frame 40, and a configuration in which the detection light irradiation device 50 is disposed inside the screen 30 and in the vicinity of the right frame side 42, the lower frame side 43, or the left frame side 44 can be adopted.

Further, the aspect of the inquiry image 325 is not limited to the embodiment described above. For example, the inquiry image 325 may be an image that prompts designation of at least one of the upper frame side 41, the right frame side 42, the lower frame side 43, and the left frame side 44. In this case, the aspect of the inquiry image 325 is not particularly limited as long as at least one of the upper frame side 41, the right frame side 42, the lower frame side 43, and the left frame side 44 can be designated.

Further, the configurations of the projection apparatus 100 shown in FIG. 3 and the terminal apparatus 300 shown in FIG. 5 represent functional configurations, and do not particularly limit specific implementation forms. That is, hardware individually corresponding to the functional sections is not necessarily required to be implemented, and it is obviously possible to adopt a configuration in which one processor executes a program to implement functions of a plurality of functional sections. Further, some of the functions implemented by software in the embodiment described above may be implemented by hardware or some of the functions implemented by hardware in the embodiment described above may be implemented by software. In addition, specific detailed configurations of other sections of the projection apparatus 100 and the terminal apparatus 300 can also be changed as appropriate without departing from the gist of the present disclosure.

Further, the processing units in the flowcharts shown in FIGS. 7, 12, 18, 22, and 28 are obtained by dividing the processing of the controller 700 in accordance with principal processing contents in order to facilitate the understanding of the processing. The way of the division and the name of the processing units shown in the flowcharts in FIGS. 7, 12, 18, 22, and 28 are not limitations, and the processing can be divided into a larger number of processing units, or can also be divided so that each of the processing units includes a larger amount of processing in accordance with the processing contents. Further, the processing order in the flowchart described above is not limited to the illustrated example.

Further, the method of controlling the terminal apparatus 300 can be realized by making the processor 370 provided to the terminal apparatus 300 execute a control program corresponding to the method of controlling the terminal apparatus 300. Further, the control program can also be recorded on a computer readable recording medium. As the recording medium, a magnetic or optical recording medium or a semiconductor memory device can be used. Specifically, there can be cited portable or stationary recording media such as a flexible disc, a hard disk drive (HDD), a compact disk read-only memory (CD-ROM), a digital versatile disk (DVD), a Blu-ray (registered trademark) disc, a magneto-optical disc, a flash memory, and a card-type recording medium. Further, the recording medium may be a RAM, a nonvolatile storage device such as a ROM or an HDD which are storage internal devices provided to the projection apparatus 100. Further, the method of controlling the terminal apparatus 300 can be realized by storing a control program corresponding to the display method of the projection apparatus 100 in advance in a server device or the like, and then downloading the control program from the server device to the projection apparatus 100.

### 10. Summary of Present Disclosure

The present disclosure will be summarized below as appendices.

### Appendix 1

A method of controlling a terminal apparatus including a camera configured to image a projection target on which an image is projected from a projection apparatus, a display, and at least one processor, the method including: making the at least one processor cause the display to display an inquiry image that asks whether an object different from the projection target is located in an area at an inner side of the projection target with respect to a first side of the projection target or the object is located in an area at an outer side of the projection target with respect to the first side of the projection target; making the at least one processor acquire a captured image of the projection target imaged by the camera; making the at least one processor calculate a first correction value for correcting at least one of a shape and a position of the image based on a second side of the projection target different from the first side in the captured image when a first response representing that the object is located in the area at the inner side with respect to the first side is received; and making the at least one processor calculate a second correction value for correcting at least one of the shape and the position of the image based on both the first side and the second side in the captured image when a second response representing that the object is located at the outer side of the projection target with respect to the first side is received.

According to the method of controlling the terminal apparatus described in Appendix 1, when the first response representing that the object is located in the area at the inner side with respect to the first side is received, the first correction value for correcting at least one of the shape and the position of the image is calculated based on the second side of the projection target. Further, when the second response representing that the object is located at the outer side of the projection target with respect to the first side is received, the second correction value for correcting at least one of the shape and the position of the image is calculated based on the first side and the second side of the projection target. Therefore, since the first correction value for correcting at least one of the shape and the position of the image is calculated based on the second side in the captured image when the first response is received, it is possible to calculate an appropriate correction value with the influence of the object reduced.

### Appendix 2

The method of controlling the terminal apparatus according to Appendix 1, wherein the object is a detection apparatus configured to detect a pointer that points a position on a projection surface provided to the projection target.

According to the method of controlling the terminal apparatus described in Appendix 2, the object is the detection apparatus configured to detect the pointer that points the position on the projection surface provided to the projection target. Therefore, even when the detection apparatus is used to detect the pointer, an appropriate correction value can be calculated.

### Appendix 3

The method of controlling the terminal apparatus according to one of Appendices 1 and 2, wherein the inquiry image includes at least one schematic diagram simulating a positional relationship between the object and one of the first side and the second side.

According to the method of controlling the terminal apparatus described in Appendix 3, the inquiry image includes at least one schematic diagram simulating the positional relationship between the object and one of the first side and the second side. Therefore, it becomes easy to figure out the inquiry content.

### Appendix 4

The method of controlling the terminal apparatus according to Appendix 1, further including: making the at least one processor calculate a cross product of a normal vector of a right side as a third side different from the first side and the second side and a normal vector of a projection surface as the projection target to calculate a horizontal vanishing point; making the at least one processor calculate a cross product of a normal vector of a lower side as the second side and the normal vector of the projection surface to calculate a vertical vanishing point; making the at least one processor identify a straight line that is a left side as a fourth side from a group of straight lines passing through the horizontal vanishing point and the lower side as the second side; and making the at least one processor identify a straight line that is the upper side as the first side from a group of straight lines passing through the vertical vanishing point and the right side.

According to the method of controlling the terminal apparatus described in Appendix 4, by identifying the lower side and the right side as the third side from the captured image, the upper side and the left side as other sides can be identified. Therefore, even when the object is located in the area inside the projection surface, it is possible to identify the four sides of the projection surface as the projection target to calculate an appropriate correction value.

### Appendix 5

The method of controlling the terminal apparatus according to Appendix 1, further including: making the at least one processor calculate a cross product of a normal vector of a left side as a fourth side different from the first side and the second side and a normal vector of a projection surface as the projection target to calculate a vertical vanishing point; making the at least one processor calculate a cross product of a normal vector of an upper side as the first side and the normal vector of the projection surface to calculate a horizontal vanishing point; making the at least one processor identify a straight line that is a right side as a third side from a group of straight lines passing through the vertical vanishing point and the upper side; and making the at least one processor identify a straight line that is the lower side as the second side from a group of straight lines passing through the horizontal vanishing point and the left side.

According to the method of controlling the terminal apparatus described in Appendix 5, by identifying the upper side and the left side as the fourth side from the captured image, the lower side and the right side as other sides can be identified. Therefore, even when the object is located in the area inside the projection surface, it is possible to identify the four sides of the projection surface as the projection target to calculate an appropriate correction value.

### Appendix 6

A non-transitory computer-readable storage medium storing a program causing a computer configured to control a terminal apparatus including a camera configured to image a projection target on which an image is projected from a projection apparatus and a display to execute processing including: causing the display to display an inquiry image that asks whether an object different from the projection target is located in an area at an inner side of the projection target with respect to a first side of the projection target or the object is located in an area at an outer side of the projection target with respect to the first side of the projection target; acquiring a captured image of the projection target imaged by the camera; calculating a first correction value for correcting at least one of a shape and a position of the image based on a second side of the projection target different from the first side in the captured image when a first response representing that the object is located in the area at the inner side with respect to the first side is received; and calculating a second correction value for correcting at least one of the shape and the position of the image based on both the first side and the second side in the captured image when a second response representing that the object is located at the outer side of the projection target with respect to the first side is received.

According to the non-transitory computer-readable storage medium storing the program described in Appendix 6, when the first response representing that the object is located in the area at the inner side with respect to the first side is received, the first correction value for correcting at least one of the shape and the position of the image is calculated based on the second side of the projection target. Further, when the second response representing that the object is located at the outer side of the projection target with respect to the first side is received, the second correction value for correcting at least one of the shape and the position of the image is calculated based on the first side and the second side of the projection target. Therefore, since the first correction value for correcting at least one of the shape and the position of the image is calculated based on the second side in the captured image when the first response is received, it is possible to calculate an appropriate correction value with the influence of the object reduced.

### Appendix 7

A projection system including: a projection apparatus including a receiving circuit configured to receive data, and configured to project an image on a projection target; and a terminal apparatus including a camera configured to image the projection target, a display, at least one processor, and a transmitting circuit configured to transmit the data, wherein the at least one processor executes causing the display to display an inquiry image that asks whether an object different from the projection target is located in an area at an inner side of the projection target with respect to a first side of the projection target or the object is located in an area at an outer side of the projection target with respect to the first side of the projection target, acquiring a captured image of the projection target imaged by the camera, calculating a first correction value for correcting at least one of a shape and a position of the image based on a second side of the projection target different from the first side in the captured image when a first response representing that the object is located in the area at the inner side with respect to the first side is received, calculating a second correction value for correcting at least one of the shape and the position of the image based on both the first side and the second side in the captured image when a second response representing that the object is located at the outer side of the projection target with respect to the first side is received, and transmitting, with the transmitting circuit, the first correction value or the second correction value to the projection apparatus, and the projection apparatus executes projecting, on the projection target, a corrected image as the image corrected based on the first correction value or the second correction value received by the receiving circuit.

According to the projection system described in Appendix 7, when the first response representing that the object is located in the area at the inner side with respect to the first side is received, the first correction value for correcting at least one of the shape and the position of the image is calculated based on the second side of the projection target. Further, when the second response representing that the object is located at the outer side of the projection target with respect to the first side is received, the second correction value for correcting at least one of the shape and the position of the image is calculated based on the first side and the second side of the projection target. Therefore, since the first correction value for correcting at least one of the shape and the position of the image is calculated based on the second side in the captured image when the first response is received, it is possible to calculate an appropriate correction value with the influence of the object reduced.

What is claimed is:

1. A method of controlling a terminal apparatus including a camera configured to image a projection target on which an image is projected from a projection apparatus, a display, and at least one processor, the method comprising:
making the at least one processor cause the display to display an inquiry image that asks whether an object different from the projection target is located in an area at an inner side of the projection target with respect to a first side of the projection target or the object is located in an area at an outer side of the projection target with respect to the first side of the projection target;
making the at least one processor acquire a captured image of the projection target imaged by the camera;
making the at least one processor calculate a first correction value for correcting at least one of a shape and a position of the image based on a second side of the projection target different from the first in the captured image when a first response representing that the object is located in the area at the inner side with respect to the first side is received; and
making the at least one processor calculate a second correction value for correcting at least one of the shape and the position of the image based on both the first side and the second side in the captured image when a second response representing that the object is located at the outer side of the projection target with respect to the first side is received.

2. The method of controlling the terminal apparatus according to claim 1, wherein
the object is a detection apparatus configured to detect a pointer that points a position on a projection surface provided to the projection target.

3. The method of controlling the terminal apparatus according to claim 1, wherein
the inquiry image includes at least one schematic diagram simulating a positional relationship between the object and one of the first side and the second side.

4. A non-transitory computer-readable storage medium storing a program causing a computer configured to control a terminal apparatus including a camera configured to image a projection target on which an image is projected from a projection apparatus and a display to execute processing comprising:
causing the display to display an inquiry image that asks whether an object different from the projection target is located in an area at an inner side of the projection target with respect to a first side of the projection target or the object is located in an area at an outer side of the projection target with respect to the first side of the projection target;
acquiring a captured image of the projection target imaged by the camera;
calculating a first correction value for correcting at least one of a shape and a position of the image based on a second side of the projection target different from the first side in the captured image when a first response representing that the object is located in the area at the inner side with respect to the first side is received; and
calculating a second correction value for correcting at least one of the shape and the position of the image based on both the first side and the second side in the captured image when a second response representing that the object is located at the outer side of the projection target with respect to the first side is received.

5. A projection system comprising:
a projection apparatus including a receiving circuit configured to receive data, and configured to project an image on a projection target; and
a terminal apparatus including a camera configured to image the projection target, a display, at least one processor, and a transmitting circuit configured to transmit the data, wherein
the at least one processor executes
causing the display to display an inquiry image that asks whether an object different from the projection target is located in an area at an inner side of the projection target with respect to a first side of the projection target or the object is located in an area at an outer side of the projection target with respect to the first side of the projection target,
acquiring a captured image of the projection target imaged by the camera,
calculating a first correction value for correcting at least one of a shape and a position of the image based on a second side of the projection target different from the first side in the captured image when a first response representing that the object is located in the area at the inner side with respect to the first side is received,
calculating a second correction value for correcting at least one of the shape and the position of the image based on both the first side and the second side in the captured image when a second response representing that the object is located at the outer side of the projection target with respect to the first side is received, and
transmitting, with the transmitting circuit, the first correction value or the second correction value to the projection apparatus, and
the projection apparatus executes projecting, on the projection target, a corrected image as the image corrected based on the first correction value or the second correction value received by the receiving circuit.
